(19) United States
(12) Patent Application Publication
(10) Pub. No.: US 2021/0137772 A1
(43) Pub. Date: May 13, 2021

(54) Multi-Functional Guide Stick

(71) Applicants: Elnathan J. Washington, Laguna Beach, CA (US); Dalerena A. Washington, Laguna Beach, CA (US)

(72) Inventors: Elnathan J. Washington, Laguna Beach, CA (US); Dalerena A. Washington, Laguna Beach, CA (US)

(21) Appl. No.: 17/061,577

(22) Filed: Oct. 1, 2020

Related U.S. Application Data
(60) Provisional application No. 62/934,430, filed on Nov. 12, 2019.

(51) Int. Cl. A61H 3/06

(52) U.S. Cl. CPC A61H 3/068; A61H 2003/065; A61H 3/061

(57) ABSTRACT

A multi-functional guide stick for the visually impaired is an apparatus with built in navigation, speech recognition, Bluetooth capabilities, fingerprint security, and close proximity environmental analysis. The apparatus is configured to analyze the user's surroundings and provide audio feedback. An auditory navigation system continuously provides the user with their current geographic location, preferably via Bluetooth headset or speaker. In addition, the apparatus also accepts voice command inputs, processes navigation requests for various destinations, and subsequently audibly conveys turn-by-turn navigation to reach said destination. Furthermore, with the use of a plurality of sensors, objects in close proximity, including vehicles moving at high speeds, are detected and information relayed to the user through auditory signals. The apparatus allows a visually impaired user to navigate the streets of the city, dangerous cross sections, and avoid obstacles with ease.

The current application claims a priority to the U.S. Provisional Patent application Ser. No. 62/934,430 filed on Nov. 12, 2019.

### FIELD OF THE INVENTION

The present invention relates generally to a guide stick for the visually impaired. More specifically, the multi-functional guide stick for the visually impaired is a walking guide stick containing a global positioning system (GPS) tracking module, a personal area network (PAN) communication module (e.g. Bluetooth), a voice recognition module, and a spatial-positioning-and orientation acquisition module.

### BACKGROUND OF THE INVENTION

Blindness is the condition defined by a substantial loss of visual perception as a result of physiological or neurological causes. While blindness is often associated with a complete lack of vision, medical blindness refers to severe visual impairment with some residual vision. According to the World Health Organization (WHO), the most common causes for blindness, listed here from most to least common, are cataracts, glaucoma, macular degeneration, corneal opacification, diabetic retinopathy, trachoma, and onchocerciasis. In addition, the prevalence of blindness is present more in developing countries than in developed countries. This is a consequence of underdeveloped healthcare infrastructure; leading treatable and preventable causes of blindness often grow out of control. With blindness due to any of these conditions comes a decreased quality of life, increased dependence on outside support, and the loss of self-sufficiency.

Some of the common treatment options include the use of canes, caretakers, and guide dogs. Regardless of the chosen mechanism for management, the user will always need someone to physically be present for guidance and support during many daily activities. Particularly, walking canes, as an omnipresent device in the daily life of a blind person, have the potential to offer much more than simple contact-based navigation. What is needed is a walking stick device that is capable of providing audible notifications to the user in response to physical stimuli. Further desirable is a tool that can help a user navigate an unfamiliar area.

The present invention seeks to provide a unique and novel solution to this problem. The multi-functional guide stick for the visually impaired is a guide stick with built in navigation, speech recognition, Bluetooth capabilities, fingerprint security, and close proximity environmental analysis. An auditory navigation system continuously provides the user with their current geographic location via Bluetooth headset. In addition, the present invention also accepts voice command inputs, processes navigation requests for various destinations, and subsequently audibly conveys turn-by-turn navigation to reach said destination. The present invention also contains close proximity environment analysis capabilities. With the use of a plurality of sensors, objects in close proximity, including vehicles moving at high speeds, are detected and information relayed to the user through auditory signals. The present invention allows a visually impaired user to navigate the streets of the city, dangerous cross sections, and avoid obstacles with ease.

### BRIEF DESCRIPTION OF THE DRAWINGS

FIG. 1 is a perspective view of a guide stick component for the present invention.

FIG. 2 is a front view of the guide stick component in an upright position.

FIG. 3 is a schematic diagram illustrating the guide stick component in wireless communication with an audio headset for the present invention, wherein the guide stick component is echolocating environmental obstructions.

FIG. 4 is a front view of the guide stick component in the upright position with cameras.

FIG. 5 is a block diagram illustrating user-control features for the present invention.

FIG. 6 is a block diagram illustrating various sensor and module inputs for the present invention.

### DETAILED DESCRIPTION OF THE INVENTION

All illustrations of the drawings are for the purpose of describing selected versions of the present invention and are not intended to limit the scope of the present invention.

The present invention is a multi-functional guide stick that is used to help blind or otherwise visually-impaired persons navigate an area. The present invention is configured to analyze the user's surroundings and provide audio feedback and navigation information. The present invention may comprise a stick body 1, a ball roller 5, a handle 6, a microcontroller 7, a location-tracking module 8, and at least one audio device 10, as shown in FIGS. 1 through 7. The stick body 1 relates to the volume of space occupied by the present invention. The ball roller 5 is a spherical unit which rotates to determine various metrics, including step count, terrain type or quality, distance, and a variety of other measurable data, depending upon how the present invention is utilized. The handle 6 relates to a preferably ergonomic hand grip which allows the user to wield the present invention while traveling. The microcontroller 7 relates to a processing device capable of accepting various inputs, applying programmed logic, and wirelessly relaying appropriate results to the appropriate parties. The location-tracking module 8 is used to monitor the geospatial position of the present invention, preferably based upon global positioning system (GPS) coordinates. The echolocation module 9 allows the present invention to emit a radio wave or pulse frequency, to subsequently receive the reflected portions of the emitted radio wave or pulse frequency, and to then convert those received portions into electronic signals for further processing. The at least one audio device 10 is used to convert electronic signals into audible sound. In an exemplary embodiment, the at least one audio device 10 relates to a Bluetooth headset; however, it is to be understood that the at least one audio device 10 can alternatively be, but is not limited to, any kind of speakers, ear buds, or other sound-transmitting tools.

The general configuration of the aforementioned components allows the present invention to efficiently and effectively assist a user in navigating through various walkable environments. The stick body 1 comprises a distal end 2 and a proximal end 3, as seen in FIG. 2. The distal end 2 relates to the portion of the stick body 1 that is preferably away from the user during use. The proximal end 3 relates to the portion of the stick body 1 that is opposite to the distal end 2 and is naturally away from the ground during use. The handle 6 is mounted onto the proximal end 3. This arrangement allows the user to control the positioning and orientation of the stick body 1. The ball roller 5 is mounted onto the distal end 2. In this way, the ball roller 5 is in regular physical contact with the ground while the present invention is in use. The microcontroller 7, the location-tracking module 8, and the echolocation module 9 are integrated into the stick body 1. This arrangement results in static positioning of the microcontroller 7, the location-tracking module 8, and the echolocation module 9 relative to each other. The echolocation module 9 is positioned adjacent to the distal end 2. In this way, the echolocation module 9 can readily emit and receive radio signals from an ideal position that is proximal to the ball roller 5. The microcontroller 7 is electronically connected to the location-tracking module 8 and the echolocation module 9. This arrangement allows for signals to be relayed to the microcontroller 7 for subsequent processing. The microcontroller 7 is communicably coupled to the at least one audio device 10. Thus, the at least one audio device 10 may receive signals in relation to the information gathered by the location-tracking module 8 and the echolocation module 9.

In order to monitor the movements of the user, the present invention requires a device to monitor the movement of the ball roller 5. To enable this, the present invention may further comprise at least one rotary position sensor 14, as represented in FIG. 6. The at least one rotary position sensor 14 relates to an electronic sensor, preferably using an infrared sensing mechanism, capable of detecting the angular position of the ball roller 5. More specifically, the at least one rotary position sensor 14 is operatively coupled to the ball roller 5, wherein the at least one rotary position sensor 14 is used to measure rotational movement of the ball roller 5. This arrangement ensures that the at least one rotary position sensor 14 is able to readily measure the angular position of the ball roller 5. The microcontroller 7 is electronically connected to the at least one rotary position sensor 14. In this way, collected measurements can be relayed from the at least one rotary position sensor 14 to the microcontroller 7 for subsequent processing.

It is often advantageous to have directions emitted out loud for the user, particularly in the event that the user is not equipped with a Bluetooth headset. To permit this, the at least one audio device 10 may further comprise at least one speaker 11, as shown in FIG. 4. The at least one speaker 11 relates to an audio projection device that allows for conversion of electronic signals into corresponding sound waves. The at least one speaker 11 is externally mounted into the proximal end 3. This arrangement ensures that audio waves are projected in the user's general direction. The microcontroller 7 is electronically connected to the at least one speaker 11. In this way, the microcontroller 7 can relay appropriate signals (e.g. signals conveying navigational information) to be received and outputted by the at least one speaker 11.

The user may benefit from the ability to give vocal commands and device authentication to the present invention, as well as to monitor and track various ambient noises. To provide this ability, the at least one audio device 10 may comprise at least one microphone 1, as represented in FIG. 3. The at least one microphone 12 relates to an audio sensor capable of registering inbound sound waves and converting those sound waves into electronic signals. The at least one microphone 12 is externally mounted into the proximal end 3. This arrangement places the at least one microphone 12 near the user's mouth, thus facilitating transfer of vocal information. The at least one microphone 12 can alternatively mounted into an external audio device such as a Bluetooth headset. Moreover, the microcontroller 7 is electronically connected to the at least one microphone 12. This arrangement enables the microcontroller 7 to receive and process signals from the at least one microphone 12.

The present invention benefits from both receiving and communicating information, confidentially. To achieve this, the present invention may further comprise a personal area network (PAN) communication module 15, as represented in FIG. 6. The PAN communication module 15 is a short-range wireless communication device, such as Bluetooth, capable of pairing appropriately-equipped items to the present invention. The at least one audio device 10 comprises an audio headset 13. The audio headset 13 relates to a tool which converts electronic signals into controlled audio output directly into a user's ear. The PAN communication module 15 is integrated into the stick body 1. In this way, the PAN communication module 15 is physically protected by the stick body 1 and proximal to relevant components. The microcontroller 7 is electronically connected to the PAN communication module 15. This arrangement enables the microcontroller 7 to respond to electronic signals from the PAN communication module 15. The audio headset 13 is positioned offset from the stick body 1. Thus, the audio headset 13 is capable of communicating with the microcontroller 7 from a small distance apart from each other. The microcontroller 7 is communicably coupled to the audio headset 13 by the PAN communication module 15. In this way, the microcontroller 7 may relay appropriate messages to the PAN communication module 15 for subsequent transmission of electronic signals and conversion into audio waves by the audio headset 13.

The user may wish for their movement data and access to any associated accounts to be secured through any of a variety of security measures. To enable secure access, the present invention may further comprise at least one biometric sensor 16, as represented in FIG. 1. The at least one biometric sensor 16 relates to a thumbprint, optical, audio, or other such tool capable of identifying the user's unique biological information and subsequently enabling access to various features of the present invention. The at least one biometric sensor 16 is integrated into the handle 6. Such positioning ensures convenient and intuitive access for the user. The microcontroller 7 is electronically connected to the at least one biometric sensor 16. Thus, the microcontroller 7 may collect and respond to signals from the at least one biometric sensor 16 in order to secure or unlock the present invention.

The present invention may improve awareness of the user's surroundings by informing the user of proximal or approaching objects, such as people or vehicles. To enable this, the present invention may further comprise at least one 360-degree-view camera 17, as represented in FIGS. 4 and 5. The at least one 360-degree-view camera 17 relates to an image-capturing device capable of capturing video data from every direction. The at least one 360-degree-view camera 17 is integrated into the stick body 1. In this way, the at least one 360-degree-view camera 17 may capture images around the stick body 1. The microcontroller 7 is electronically connected to the at least one 360-degree-view camera 17. Thus, images and video captured by the at least one 360-degree-view camera 17 are transmitted to the microcontroller 7 for subsequent processing.

In an exemplary embodiment, the present invention may wish to capture 3-dimensional images or video from different positions along the stick body 1. To enable this, the at least one 360-degree-view camera 17 may comprise a first 360-degree-view camera 18 and a second 360-degree-view camera 19, as represented in FIG. 4. The first 360-degree-view camera 18 and the second 360-degree-view camera 19 are cameras capable of capturing the full area around the stick body 1. The first 360-degree-view camera 18 is positioned adjacent to the proximal end 3. This arrangement enables the first 360-degree-view camera 18 to capture images and video surrounding the handle 6. The second 360-degree-view camera 19 is positioned adjacent to the distal end 2. This enables the second 360-degree-view camera 19 to capture images and video surrounding the ball roller 5.

A visually-impaired user requires a mechanism by which to interact with the present invention. To achieve this, the present invention may further comprise a refreshable braille display 20, as represented in FIG. 2. The refreshable braille display 20 relates to a series of actuators which rise and fall to correspond with the braille alphabet, thus enabling users to read messages and generally interface with the present invention. The refreshable braille display 20 is integrated into the handle 6. This arrangement allows the user to read messages by holding the present invention from the handle 6. The microcontroller 7 is electronically connected to the refreshable braille display 20. In this way, appropriate messages regarding input from the microcontroller 7 may be relayed and displayed by the refreshable braille display 20.

The user of the present invention may be visually impaired without being fully blind and may therefore benefit from a viewable screen. To provide for this, the present invention may further comprise a visual display 21, as shown in FIG. 1. The visual display 21 may relate to any of liquid-crystal displays (LCDs), touchscreen displays, or other such devices capable of presenting various outputs from the microcontroller 7. The visual display 21 is integrated into the handle 6. This arrangement allows the user to easily and intuitively read or observe the visual display 21. The microcontroller 7 is electronically connected to the visual display 21. Thus, information from various sensors and views subsequently can be rendered by the microcontroller 7 and can then be viewed by the user on the visual display 21.

The user of the present invention may benefit from increased visibility by way of stronger illumination. To enable this, the present invention may further comprise a flashlight 22, as represented in FIGS. 2 and 5. The flashlight 22 is used to generate light in order to better illuminate a desired area. The flashlight 22 is laterally mounted to the stick body 1. This allows the user to illuminate areas proximal to the stick body 1. The flashlight 22 is oriented towards the distal end 2. Thus, the flashlight 22 may illuminate the user's path ahead during use. The microcontroller 7 is electronically connected to the flashlight 22. In this way, the microcontroller 7 may activate or deactivate the flashlight 22.

The user requires a mechanism by which to properly interface with the present invention. To this end, the present invention may further comprise at least one user control 23, as represented in FIG. 5. The at least one user control 23 relates to a set of buttons, switches, levers, touchscreen surfaces, or a plurality of other mechanisms by which the user may affect the function of the present invention. The at least one user control 23 is integrated into the handle 6. In this way, the at least one user control 23 is made easily accessible to the user holding the present invention. The microcontroller 7 is electronically connected to the at least one user control 23. Thus, the microcontroller 7 may respond appropriately to commands and inputs made by the user through the at least one user control 23.

The present invention may connect wirelessly to the Internet or to other users in order to enable remote control of the present invention, as well as to enable long-distance communication between a user and a remote operator or consultant with access to the information collected and managed by the present invention. To enable this, the present invention may further comprise a wide area network (WAN) communication module 24, as represented in FIG. 6. The WAN communication module 24 relates to a device which enables long distance communication between the present invention and authorized third parties. The WAN communication module 24 is integrated into the stick body 1. This arrangement enables the stick body 1 to protect the WAN communication module 24 as well as to allow the WAN communication module 24 proximity to relevant components. The microcontroller 7 is electronically connected to the WAN communication module 24. In this way, the present invention may communicate wirelessly with authorized third parties.

The user may require a device that reduces the chance of incident, physical damage, or loss of the present invention. To provide for this, the present invention may further comprise a carrying strap 25, as shown in FIG. 1. The carrying strap 25 relates to a band of flexible material, potentially arranged as a wrist strap near the handle 6, which enables the strap to be coupled to the user, preferably wrapped around the user's wrist. The carrying strap 25 is connected onto the proximal end 3. This arrangement enables the user to connect the carrying strap 25 around the wrist or forearm holding the handle 6.

The user may benefit from the increased portability made possible by the lengthwise collapsibility of the stick body 1. To this end, the stick body 1 comprises a plurality of telescopic tubular members 4, as represented in FIG. 4. The plurality of telescopic tubular members 4 relates to a set of interlocking rigid units. The plurality of telescopic tubular members 4 is slidably and serially engaged to each other. This arrangement enables the stick body 1 to expand and contract as desired by the user.

Although the invention has been explained in relation to its preferred embodiment, it is to be understood that many other possible modifications and variations can be made without departing from the spirit and scope of the invention as hereinafter claimed.

What is claimed is:

1. A multi-functional guide stick comprises:
a stick body;
a ball roller;
a handle;
a microcontroller;
a location-tracking module;
an echolocation module;
at least one audio device;
the stick body comprises a distal end and a proximal end;
the handle being mounted onto the proximal end;
the ball roller being mounted onto the distal end;
the microcontroller, the location-tracking module, and the echolocation module being integrated into the stick body;
the echolocation module being positioned adjacent to the distal end;
the microcontroller being electronically connected to the location-tracking module and the echolocation module; and
the microcontroller being communicably coupled to the at least one audio device.

2. The multi-functional guide stick as claimed in claim 1 comprises:
at least one rotary position sensor;
the at least one rotary position sensor being operatively coupled to the ball roller, wherein the at least one rotary position sensor is used to measure rotational movement of the ball roller; and
the microcontroller being electronically connected to the at least one rotary position sensor.

3. The multi-functional guide stick as claimed in claim 1 comprises:
the at least one audio device comprises at least one speaker;
the at least one speaker being externally mounted into the proximal end; and
the microcontroller being electronically connected to the at least one speaker.

4. The multi-functional guide stick as claimed in claim 1 comprises:
the at least one audio device comprises at least one microphone;
the at least one microphone being externally mounted into the proximal end; and
the microcontroller being electronically connected to the at least one microphone.

5. The multi-functional guide stick as claimed in claim 1 comprises:
a personal area network (PAN) communication module;
the at least one audio device comprises an audio headset;
the PAN communication module being integrated into the stick body;
the microcontroller being electronically connected to the PAN communication module;
the audio headset being positioned offset from the stick body; and
the microcontroller being communicably coupled to the audio headset by the PAN communication module.

6. The multi-functional guide stick as claimed in claim 1 comprises:
at least one biometric sensor;
the at least one biometric sensor being integrated into the handle; and
the microcontroller being electronically connected to the at least one biometric sensor.

7. The multi-functional guide stick as claimed in claim 1 comprises:
at least one 360-degree-view camera;
the at least one 360-degree-view camera being integrated into the stick body; and
the microcontroller being electronically connected to the at least one 360-degree-view camera.

8. The multi-functional guide stick as claimed in claim 7 comprises:
the at least one 360-degree-view camera comprises a first 360-degree-view camera and a second 360-degree-view camera;
the first 360-degree-view camera being positioned adjacent to the proximal end; and
the second 360-degree-view camera being positioned adjacent to the distal end.

9. The multi-functional guide stick as claimed in claim 1 comprises:
a refreshable braille display;
the refreshable braille display being integrated into the handle; and
the microcontroller being electronically connected to the refreshable braille display.

10. The multi-functional guide stick as claimed in claim 1 comprises:
a visual display;
the visual display being integrated into the handle; and
the microcontroller being electronically connected to the visual display.

11. The multi-functional guide stick as claimed in claim 1 comprises:
a flashlight;
the flashlight being laterally mounted to the stick body;
the flashlight being oriented towards the distal end; and
the microcontroller being electronically connected to the flashlight.

12. The multi-functional guide stick as claimed in claim 1 comprises:
at least one user control;
the at least one user control being integrated into the handle; and
the microcontroller being electronically connected to the at least one user control.

13. The multi-functional guide stick as claimed in claim 1 comprises:
a wide area network (WAN) communication module;
the WAN communication module being integrated into the stick body; and
the microcontroller being electronically connected to the WAN communication module.

14. The multi-functional guide stick as claimed in claim 1 comprises:
a carrying strap; and
the carrying strap being connected onto the proximal end.

15. The multi-functional guide stick as claimed in claim 1 comprises:
the stick body comprises a plurality of telescopic tubular members; and
the plurality of telescopic tubular members being slidably and serially engaged to each other.
